(19) United States
(12) Patent Application Publication
(10) Pub. No.: US 2022/0166785 A1
(43) Pub. Date: May 26, 2022

(54) DATA CENTER SECURITY SYSTEM

(71) Applicant: InVue Security Products Inc., Charlotte, NC (US)

(72) Inventors: Jeffrey A. Grant, Charlotte, NC (US); Laura Abbott Lynch, Charlotte, NC (US); Chris Bouchat, Charlotte, NC (US); Justin Hinson, Charlotte, NC (US)

(21) Appl. No.: 17/529,824

(22) Filed: Nov. 18, 2021

Related U.S. Application Data
(60) Provisional application No. 63/187,747, filed on May 12, 2021.
(60) Provisional application No. 63/178,909, filed on Apr. 23, 2021.
(60) Provisional application No. 63/116,562, filed on Nov. 20, 2020.

(51) Int. Cl. H04L 9/40; H04L 67/12

(52) U.S. Cl. CPC H04L 63/1416; H04L 67/12

(57) ABSTRACT

Sensors, systems, and methods for data center security are provided. In one example, a data center monitoring system includes at least one sensor configured to be attached to a fixture in a data center. The sensor is configured to transmit a wireless signal for detecting an unauthorized access attempt to the fixture. The system also includes at least one monitoring device configured to communicate with the at least one sensor. The monitoring device is configured to receive a signal from the at least one sensor indicative of the unauthorized access attempt to the fixture.

### CROSS REFERENCE TO RELATED APPLICATIONS

This application is a non-provisional of and claims the benefits of priority to U.S. Provisional Application No. 63/187,747, filed on May 12, 2021; U.S. Provisional Application No. 63/178,909, filed on Apr. 23, 2021; and U.S. Provisional Application No. 63/116,562, filed on Nov. 20, 2020, the entire contents of each of which are hereby incorporated by reference.

### FIELD OF THE INVENTION

Embodiments of the present invention are directed towards data center security systems, including security systems for server racks and cabinets.

### BACKGROUND

Data centers house a variety of types of equipment, some of which contain valuable information. Access to data centers may be restricted in some cases to authorized persons. However, additional safeguards would be beneficial for further securing the equipment and information from unauthorized access within data centers.

### BRIEF SUMMARY

Embodiments of the present invention are directed toward data center monitoring systems. In one example, the system includes at least one sensor configured to be attached to a fixture in a data center, wherein the at least one sensor is configured to transmit a wireless signal for detecting an unauthorized access attempt to the fixture. The system also includes at least one monitoring device configured to communicate with the at least one sensor, wherein the at least one monitoring device is configured to receive a signal from the at least one sensor indicative of the unauthorized access attempt to the fixture.

In another embodiment, a data center monitoring system comprises a plurality of server racks located in a data center and a plurality of sensors each configured to be attached to a respective server rack. Each sensor is configured to transmit a wireless signal for detecting an unauthorized access attempt to the server rack. The system further includes at least one monitoring device configured to communicate with each of the plurality of sensors, wherein the at least one monitoring device is configured to receive a signal from each of the plurality of sensors indicative of an unauthorized access attempt to a respective server rack.

In another embodiment, a method for monitoring a data center is provided. The method includes transmitting a wireless signal with at least one sensor attached to a fixture in a data center for detecting an unauthorized access attempt to the fixture. In addition, the method includes receiving a signal at a monitoring device from the at least one sensor indicative of the unauthorized access attempt to the fixture.

### BRIEF DESCRIPTION OF THE DRAWINGS

FIG. 1 is a front view of a data center monitoring system according to one embodiment of the present invention.

FIG. 2 is a top view of the data center monitoring system shown in FIG. 1.

FIG. 3 is a partial perspective view of a data center monitoring system according to one embodiment of the present invention.

FIG. 4 is a perspective view of a data center monitoring system according to another embodiment of the present invention.

FIG. 5 is a perspective view and a detail view of a data center monitoring system according to another embodiment of the present invention.

FIG. 6 is a perspective view illustrating various states of a sensor in a data monitoring system according to one embodiment.

FIG. 7 is a partial perspective view of a data center monitoring system according to one embodiment of the present invention.

FIG. 8 is a partial perspective view of a data center monitoring system according to another embodiment of the present invention.

FIG. 9 is a partial perspective view of a data center monitoring system according to one embodiment of the present invention.

FIG. 10 is a partial perspective view of a data center monitoring system according to one embodiment of the present invention.

FIG. 11 is a partial perspective view of a data center monitoring system according to one embodiment of the present invention.

FIG. 12A illustrates a sensor and a reflective component according to one embodiment of the present invention.

FIG. 12B illustrates a sensor and a reflective component according to another embodiment of the present invention.

FIG. 12C illustrates the reflection of signals between a sensor and different reflective components according to embodiments of the present invention.

FIG. 13 illustrates another example of a sensor and a reflective component according to one embodiment of the present invention.

FIG. 14 is a perspective view of a data center monitoring system according to one embodiment of the present invention.

FIG. 15 is a partial perspective view of a data center monitoring system showing an access control point in an armed state according to one embodiment of the present invention.

FIG. 16 is a partial perspective view of a data center monitoring system showing an access control point in a disarmed state according to one embodiment of the present invention.

### DETAILED DESCRIPTION OF EMBODIMENTS OF THE INVENTION

Referring to the accompanying figures wherein identical reference numerals denote the same elements throughout the various views, the illustrated embodiments of methods and systems according to the present invention are capable of monitoring a variety of equipment in a data center environment, such as for example, server racks for storing various types and quantities of computer and/or network equipment, (e.g., servers, computers, hard drives, media storage, routers, hubs, network switches, etc.). The server rack may define an enclosure that is configured to secure various computer and/or network equipment that is only able to be accessed by authorized personnel, such as described in the following embodiments. Many different forms of server racks may be employed, including those with doors (e.g., a cabinet) or no doors. Embodiments of the present invention provide security systems for protecting equipment from theft in a data center environment that may include valuable data as well as providing various data regarding accesses or attempted accesses to the equipment. Although described in relation for use in a data center environment, the system shown and described herein is suitable for monitoring and/or securing various items in other settings, such as for example, a retail, residential, or commercial environment, and is not intended to be limited to use only as a system for protecting against theft and/or monitoring equipment in a data center environment.

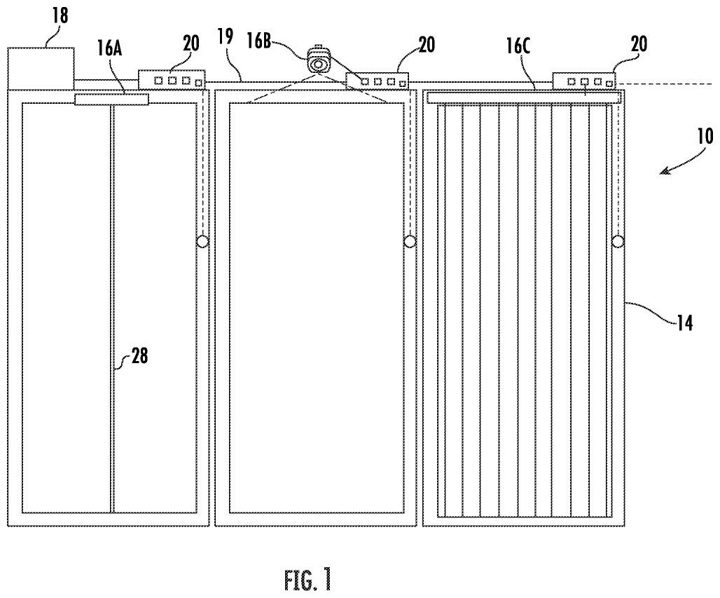

According to one embodiment, the system 10 generally comprises one or more fixtures 14, sensors 16 (specific sensor types are also referenced herein as 16A, 16B, 16C), and monitoring devices 18. In some embodiments, the fixture 14 may be an existing or off-the-shelf device, such as a server rack cabinet, and the sensor 18 is configured to be attached to the fixture. For example, FIG. 1 shows a plurality of sensors 16A, 16B, 16C coupled to respective fixtures 14. Each sensor 16 may be coupled to the fixture 14 in any desired manner, such as via adhesive, brackets, and/or fasteners.

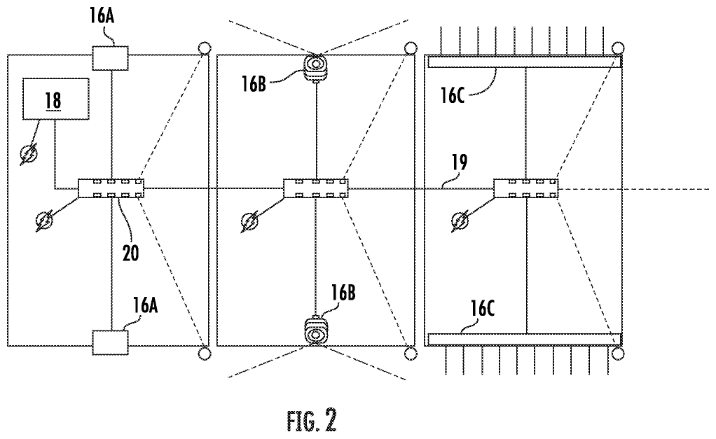

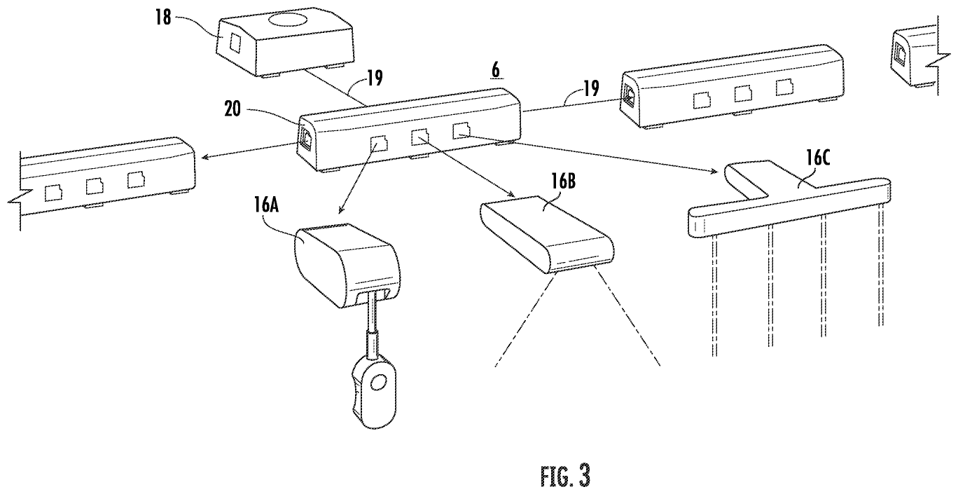

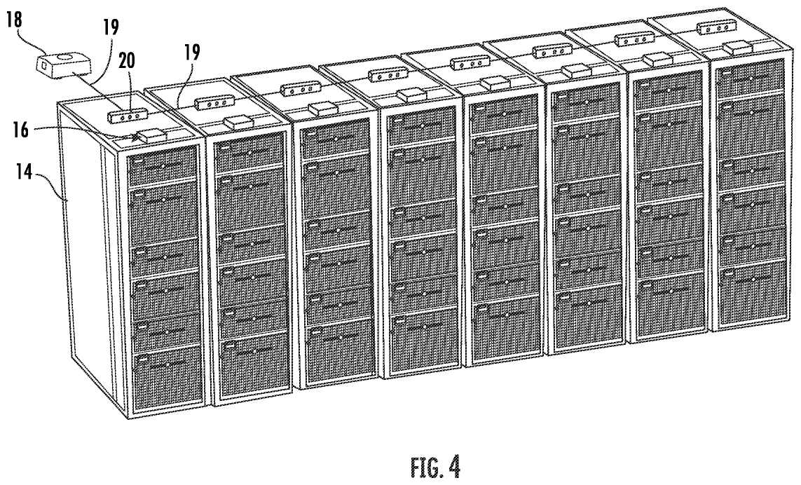

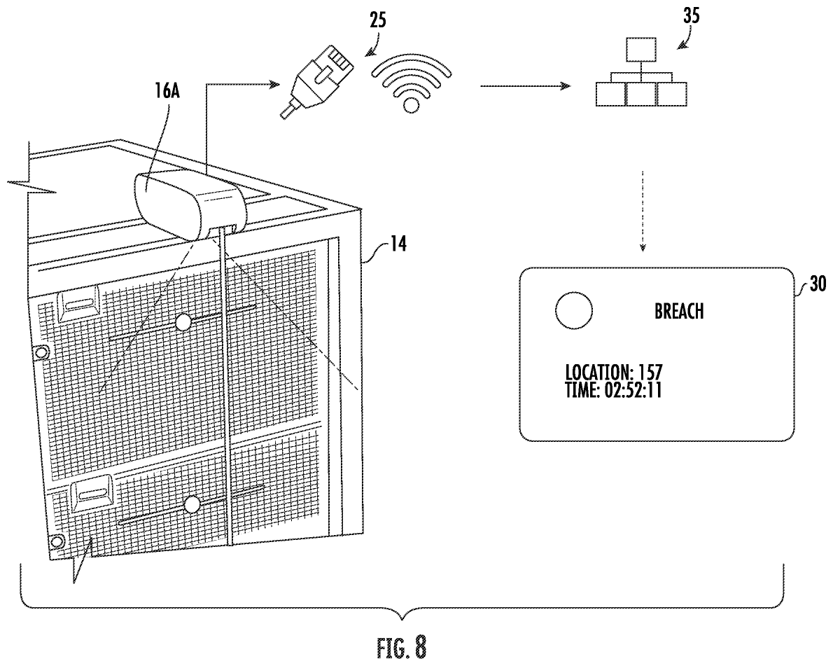

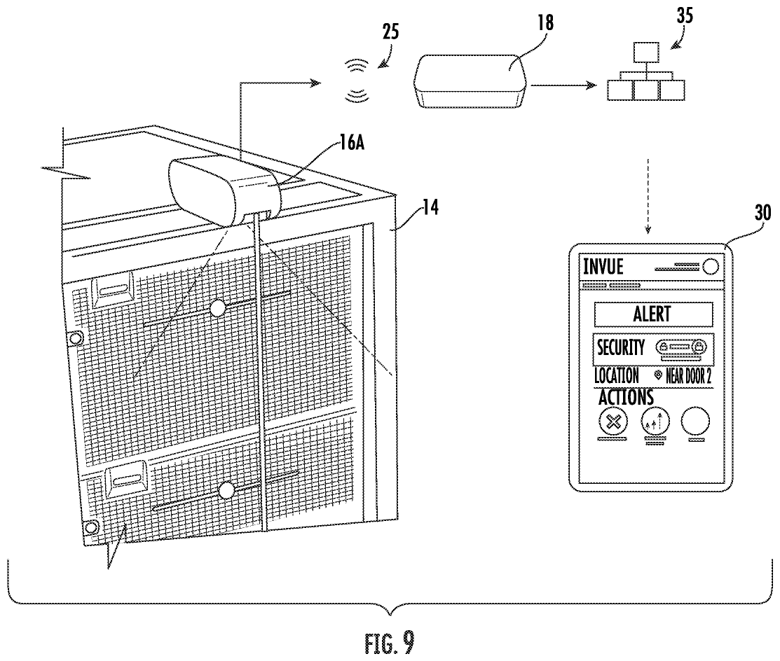

The monitoring device 18 may be any device (e.g., a controller, hub, gateway, computer, server, and/or cloud device) configured to communicate with one or more sensors 16. For instance, the monitoring device 18 may be a hub configured to communicate with a plurality of sensors 16. In other cases, the monitoring device 18 may be a computer (e.g., tablet, laptop, or desktop computer) that is configured to communicate with one or more sensors 16 and/or one or more hubs to facilitate data transfer (see, e.g., FIGS. 8 and 9). It is understood that any number of monitoring devices 18 may be employed in the system 10. Furthermore, FIG. 1 demonstrates that in one embodiment, the system 10 may include one or more junction boxes 20 that are configured to couple to a plurality of sensors 16A, 16B, 16C. It is understood that the junction boxes 20 may connect to any desired number of sensors 16. The junction boxes 20 may include input ports for facilitating an electrical connection with respective cable connectors. The junction boxes 20 may be used, for instance, to allow multiple sensors 16 to monitor respective fixtures 14 or to provide multiple sensors per each fixture (e.g. for monitoring access points such as a front and rear opening of the fixture as shown in FIG. 2). Thus, in some embodiments, the sensors 16 may be arranged in a “daisy chain” using one or more junction boxes 20 (see, e.g., FIG. 4). In addition, the junction boxes 20 may be configured to facilitate data transfer between the monitoring device 18 and the sensors 14. Thus, the monitoring device 18 may be configured to facilitate communication with a plurality of sensors 16 and/or junction boxes 20 via wired (e.g., one or more cables 19 as shown in FIGS. 1-2) or wireless means (e.g., FIG. 9).

In some embodiments, the monitoring device 18 and/or junction boxes 20 may be omitted. In this case, the sensors 16 (or sensor array) may be configured to perform the functionality of the monitoring device 18 and/or the junction boxes 20, which may provide for more flexibility of installation and power conservation. In this regard, one or more sensors 16 (or sensor arrays) may be operably connected to an access control point 42. In addition, one or more sensors 16 (or sensor arrays) may be configured to operably connect to a power-over-ethernet (“PoE”) cable for data and power transmission. For example, the access control point 42 may be configured to operably connect to a plurality of sensors 16 (or sensor arrays), while each sensor or sensor array may have its own POE connection. In this configuration, each sensor 16 or sensor array may have its own unique identifier (e.g., via IP address or serial number) for access control and auditing purposes. In some cases, the sensors 16 (or sensor array) may include a separate battery backup in the event of a power loss so that the sensors or sensor array may continue to operate as intended.

The sensors 16 and/or the monitoring device 18 may include wireless communications circuitry for communicating with one another using any desired communications protocol (e.g., Bluetooth, LoRa, Wi-Fi, radiofrequency, etc.). The sensor 16 and monitoring device 18 may be located remotely from one another (e.g., the sensors may be located in a data center, while the monitoring device may be at a location that is not in the data center). In some cases, the monitoring device 18 may be located at some fixed location in proximity to one or more sensors 16 (e.g., attached to a fixture 14). In other instances, the sensors 16 and the monitoring device 18 may communicate over a cloud network. In some embodiments, the sensors 16 and the monitoring device 18 are electrically connected via hard wiring (see, e.g., FIG. 1), and the monitoring device may have wireless communications circuitry for communicating with other monitoring devices or remote computing devices.

There may be any number of sensors 16 used in the system 10 (e.g., hundreds in a large data center) that are configured to communicate with one or more monitoring devices 18. Moreover, a plurality of sensors 16 may form a single assembly or array for each fixture 14. In order to facilitate long range communications that could potentially have interference from various fixtures, products, and even people in a data center, a communications scheme in the sub-gig range may be desirable in some embodiments (e.g., the LoRa protocol). Long range communication protocols of this nature may minimize repeaters and a more difficult initial setup, as well as help maintain connectivity when the sensors 16 are moved around in the data center at some point after installation. In one embodiment, the sensor 16 may require authorization to facilitate communication with the monitoring device 18. For example, the sensor 16 may receive an authorization signal via a long-range communication signal from the monitoring device 18 to activate the sensor. Another signal could also be sent from the monitoring device 18 to the sensor instructing the sensor to deactivate. Despite the foregoing, it is understood that the sensor 16 and monitoring device 18 may communicate via wired means if desired.

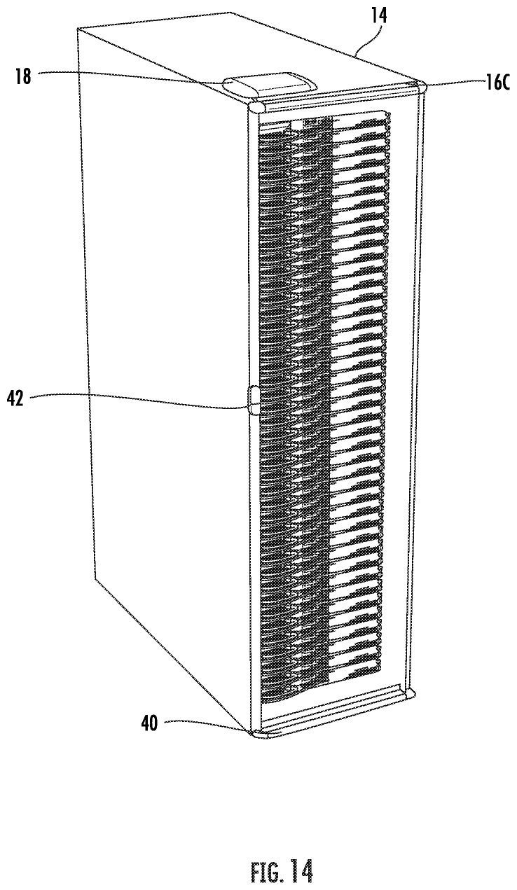

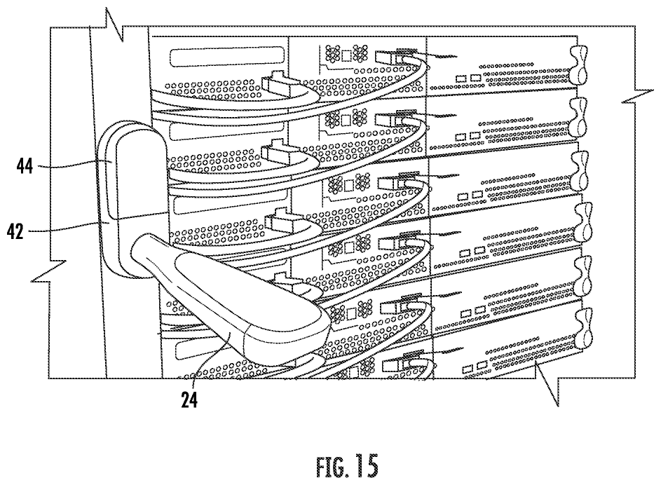

In some embodiments, the sensor 16 may be configured to communicate with an electronic key 24 configured to activate, unlock, and/or reset the sensor. Similarly, each of the fixtures 14 may include an interface for communicating with an electronic key 24 for accessing the fixture (e.g., to unlock a door to a server cabinet or to allow authorized access to the equipment). The electronic key 24 may be configured to interface with the fixture 14 or any component of the system 10 (e.g., an access control point 42 mounted on the fixture) for authorizing a user to access the fixture 14 (see, e.g., FIGS. 14 and 15). Communication between the electronic key 24 and the access control point 42 may be wireless in some cases. In one example, access may be granted when a code stored on the electronic key 24 matches a code stored in memory at the access control point 42. For example, the electronic key 24 could be similar to that disclosed in U.S. Publ. No. 2011/0254661, entitled Programmable Security System and Method for Protecting Merchandise, the disclosure of which is incorporated herein by reference in its entirety.

It is understood that various types of access control points 42 may be used according to additional embodiments, including those where an electronic key 24 is not required. For example, a pin pad, biometrics, etc. may be used to allow access to the fixture 14. In other embodiments, the access control point 42 may operate in conjunction with a ticketing system in which a user is granted a predetermined period of time to access the fixture 14. For example, access management and maintenance may be managed through a ticketing system where certain fixtures 14 are assigned to a technician to perform maintenance. Once at the authorized fixture 14, the user may be required to provide input to confirm that the technician is present. For instance, the user may be required to provide a hand gesture indicative of a symbol, letter, word, etc. that confirms that the user is present. In some cases, the hand gesture may be made within the transmission path or “light curtain” of the sensors 16 (discussed below) so that the sensors may be configured to detect the gesture and in some cases, confirm and/or record the gesture for auditing purposes.

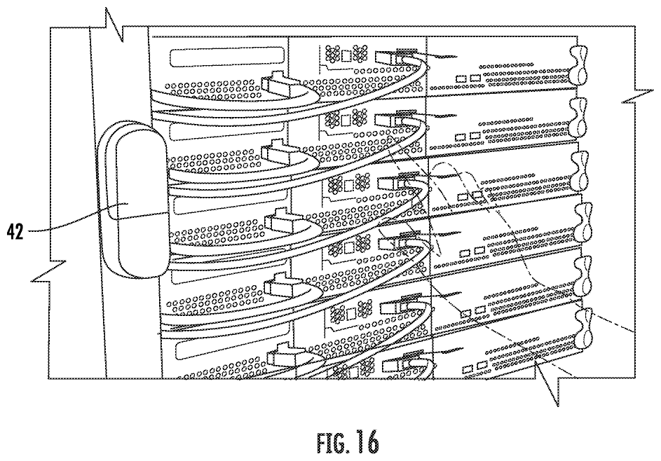

FIGS. 15 and 16 illustrate embodiments where the access control point 42 includes an interface for an electronic key 24 and a visible indicator 44. The visible indictor 44 may be configured to change in color based on the state of the access control point (e.g., armed, disarmed, access, or breach). For example, the visible indicator 44 may be configured to change colors when the access control point 42 transitions from an armed state to a disarmed state. In the disarmed state, a user may be able to access contents within the fixture 14 without generating an alarm signal. However, in the disarmed state, data representing access and access attempts may be monitored and recorded by the monitoring device 18 for audit purposes. Moreover, the visible indicator 44 may be configured to transition to another color when there is an authorized or unauthorized access attempt so that the user knows that the access or attempt has been detected. In some cases, the monitoring device 18 may be configured to automatically rearm after a predetermined period of time after being disarmed to ensure that the monitoring device is armed. Thus, a user may be allowed a limited amount of time before the system 10 is rearmed. The visible indicator 44 may be configured to flash or transition to another color when the end of the predetermined period of time before rearming is nearing.

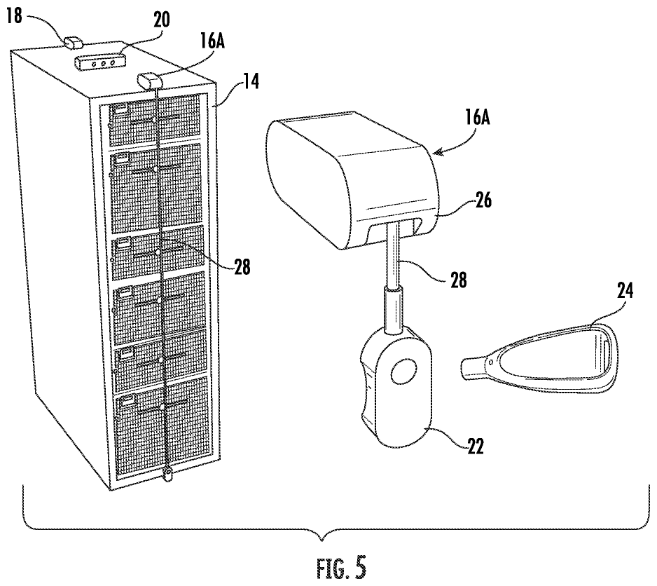

The sensor 16 may utilize various sensing techniques to detect unauthorized access attempts to the fixture 14, such as an attempt to remove or tamper a server without authorization. For instance, FIGS. 1-2 show that the sensors 16A, 16B, 16C may employ physical, visual, and/or optical sensing for such purposes. FIGS. 5-9 illustrate an embodiment using a physical security sensor 16A. In this regard, the sensor 16 may include a security device 22 that is configured to be operated by an electronic key 24. In some cases, the security device 22 is configured to cooperate with the electronic key 24 for locking and/or unlocking a lock mechanism for accessing the fixture 14. In some embodiments, the electronic key 24 is also configured to arm and disarm an alarm circuit. FIG. 5 shows that the sensor 16A generally includes a base 26 configured to be secured to the fixture 14. In one example, sensor 16A may include an alarm circuit that is configured to be armed and/or disarmed with the electronic key 24. However, in other embodiments, the sensor 16A may simply provide mechanical security for securing the sensor to the fixture 14. The sensor 16A further includes a tether 28 that is configured to extend and retract relative to the base 26. The tether 28 may be coupled to base 26 at one end and the security device 22 at an opposite end. The tether 28 may be any suitable cable, cord, or the like, and in some cases, may be flexible. In one embodiment, the tether 28 is coupled to a recoiler that is wound within the base 26 and is configured to unwind as tension is applied to the end of the tether. For instance, FIG. 5 shows that the tether 28 may be extended the length of the fixture 14 for at least partially blocking access to the fixture such that any attempted removal of equipment contained by the fixture 14 would require removing the tether. The security device 22 may lock the tether 28 in its extended position such as by locking the security device to the fixture 14. The security device 22 may lock to an end of the tether 28 such that unlocking the security device allows the tether to retract within the base 26. The end of the tether 28 may include a connector or other engagement member that is configured to be engaged with and disengaged from the security device 22. The security device 22 may include a wireless interface (e.g., IR or inductive interface) that is configured to communicate with the electronic key 24 for locking and/or unlocking the lock mechanism of the security device.

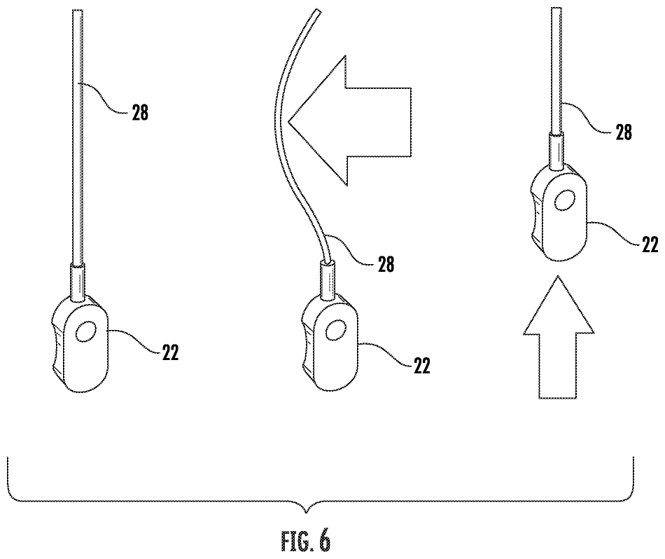

In some embodiments, the tether 28 provides mechanical security only, while in other embodiments, the tether may include one or more conductors electrically connected to an alarm circuit. Thus, the sensor 16A may be configured to detect when the tether 28 is cut or removed from the base 26 in an unauthorized manner or if the tether has been displaced (see, e.g., FIG. 6). In other embodiments, the tether 28 may include both a cut resistant cable and conductors, although only a cut-resistant cable may be utilized if desired. Moreover, the base 26 may include a sensor that is configured to be activated upon unauthorized removal of the base from the fixture 14, and the sensor may in electrical communication with an alarm circuit. For example, the sensor may be a pressure or plunger switch. Thus, the sensor 16A and/or base 26 may include an alarm circuit configured to detect activation thereof and to generate an audible and/or a visible alarm signal in response to such activation. For example, the sensor 16A may be configured to detect the activation and notify a monitoring device 18 for generating an alarm signal and/or sending a notification to a remote device 30 (see, e.g., FIG. 8 showing an alert message including the location and time of breach).

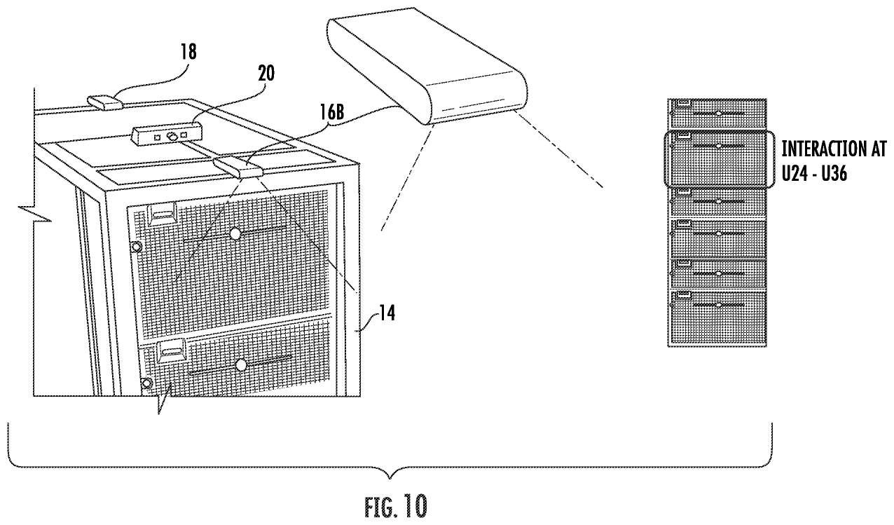

In another embodiment, the sensor 16 may utilize vision technology (see, e.g., FIG. 10). For example, one or more cameras may be used for monitoring a fixture 14. For instance, FIG. 2 shows that sensors 16B in the form of cameras may be located on a front and rear surface of a fixture 14 for monitoring different access points to the fixture. In one embodiment, the sensor 16B may utilize machine learning or artificial intelligence (“AI”) for obtaining various types of data and monitoring activities at the fixture 14. The camera could be positioned to view items contained by the fixture 14, the fixture itself, and/or locations around the fixture. The camera may also be configured to obtain details related to the items, fixture 14, and/or humans interacting with the fixture. For example, FIG. 10 shows that the camera may be configured to identify a specific zone, location, or piece of equipment associated with a fixture 14 (e.g., interaction at “U24-36”). The camera may be configured to record and/or communicate this information to the monitoring device 18.

In one embodiment, the system 10 also includes a computerized machine learning or AI model including various data and algorithms. In some instances, the model may reside on the monitoring device 18 and/or sensor 16B. For instance, the cameras may be configured to communicate data to the monitoring device 18 for taking various actions, such as providing notification of various events (e.g., theft attempt), such as via messages or alerts to one or more remote devices 30. Alternatively, the cameras 48′ may be configured to execute the model and communicate directly with one or more remote devices 30 (e.g., using a cloud network). The model may be populated with various information to facilitate analysis and predictions of various types of information and behaviors in a data center environment. For example, types of information that may be provided to the model include photographs and/or geometries of the equipment and/or fixtures 14, identifying information on the equipment and/or fixtures (e.g., barcodes or QR codes), flashing LEDs or light source signatures or patterns sensors 16, sounds originating from the system 10, details regarding the surroundings (e.g., layout of fixtures within a data center), particular motions or behaviors that are indicative of an authorized or unauthorized access attempt, etc. This example model would be configured to detect and/or predict various information relevant to the system including, but not limited to, determining whether access attempts are authorized or unauthorized.

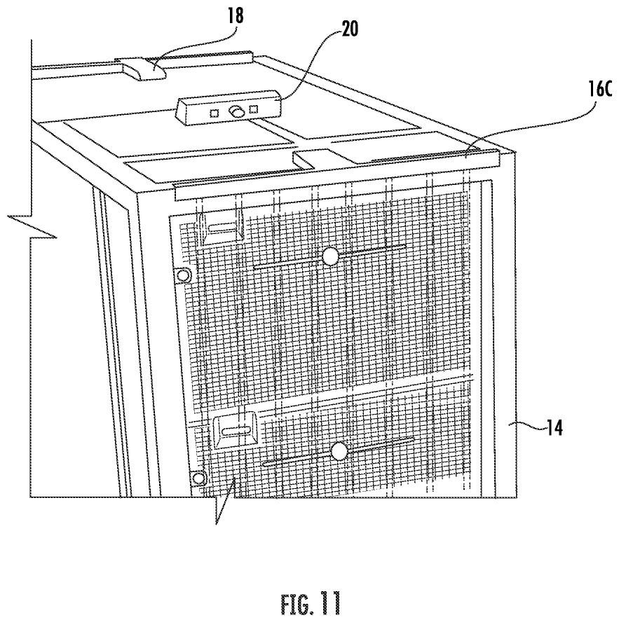

In another embodiment, the sensor 16C may employ sonic time of flight, light, and/or ultrasonic signals. In one particular example, ultrasonic frequencies may be used to measure the time of flight of the sound pulse. In other cases, the sensor 16C is configured to emit a light signal (e.g., infrared) that is used to obtain a distance measurement. In another embodiment, the sensor 16C may employ optical signals for detecting activity at the fixture 14 (see, e.g., FIG. 11). In some cases, the sensor 16 is an array of optical emitters. The array of sensors 16 could be arranged along at least a portion of the width of the fixture 14 or the entire width of the fixture. In some cases, the array of sensors 16 could define a “light curtain” that is configured to cover the entire access opening of the fixture 14. The sensor 16C may be located along a top surface of the fixture 14 and be configured to generate a signal towards a bottom surface of the fixture or vice versa. The signals may be various types of signals such as, for example, encoded or unique signals that are difficult to replicate or otherwise spoof. As noted above, the sensor(s) 16C may be used to detect unauthorized activity at the fixture 14 (e.g., attempting to access a server rack or remove equipment from a server rack).

The sensor 16C may include an emitter configured to emit a signal (e.g., sound or light) that is configured to bounce (or reflect) off the fixture 14 or any other designated target and then return to the emitter. Thus, the sensor 16C may be a transceiver configured to transmit and receive signals in some embodiments. Using the speed of the signal and the time between the ping, the return distance can be measured. With a known fixture 14 size (e.g., a height of a server cabinet), the presence of an item or person can be calculated. In some cases, distance could also be measured based on the return signal, which could be used to determine how many items are stored on a particular fixture 14. In another example, the sensor 16C may use sonic power (amplitude) for determining the presence of items or persons. In this embodiment, the sensor 16C may be configured to measure the decay of amplitude of the returning signal. The further the wave travels, the lower the power level becomes. By setting an expected threshold for decay, one could determine if any item or person is located between the sensor 16C and the target on the fixture 14. In other embodiments, additional sensors 16C may be used to communicate with the emitter, such as a receiver, to detect access attempts to the fixture 14. For example, an array of emitters may be located along a top surface of the fixture 14 while an array of receivers may be located along a bottom surface of the fixture, although the array of emitters and receivers could be located at any desired location. In one embodiment, a location of the sensor 16C or array of sensors could be adjustable, such as for accommodating different sizes and configurations of fixtures 14 to ensure that the access points to the fixture are sufficiently secure. For instance, the sensor 16C or array of sensors may be mounted to a track or bracket to facilitate adjustment in or more directions (e.g., X, Y, and/or Z directions). The adjustability of the location of the sensor 16C or array of sensors may also be helpful in ensuring that the field of view is directed in an accurate manner relative to the fixture 14 and equipment contained therein. Similarly, the field of view of the sensor 16C or array of sensors may be adjustable for a similar purpose. For instance, the angle of the field of view may be adjustable.

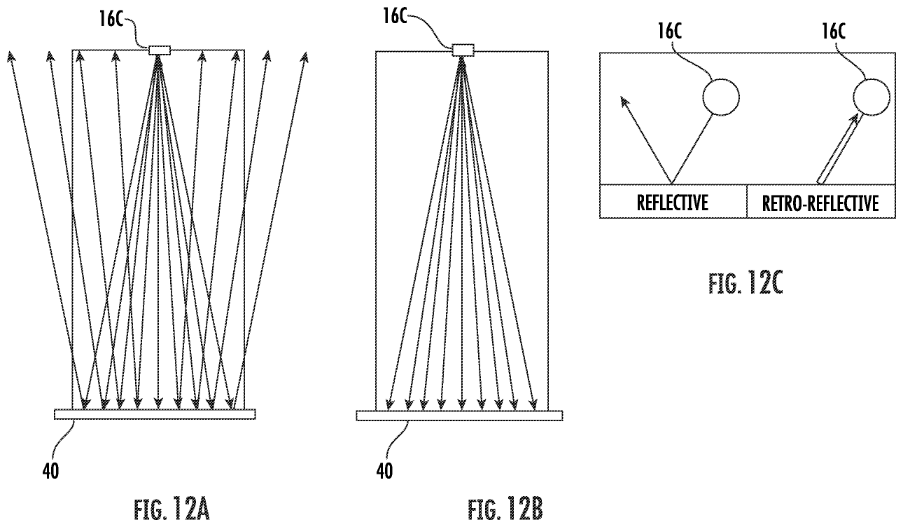

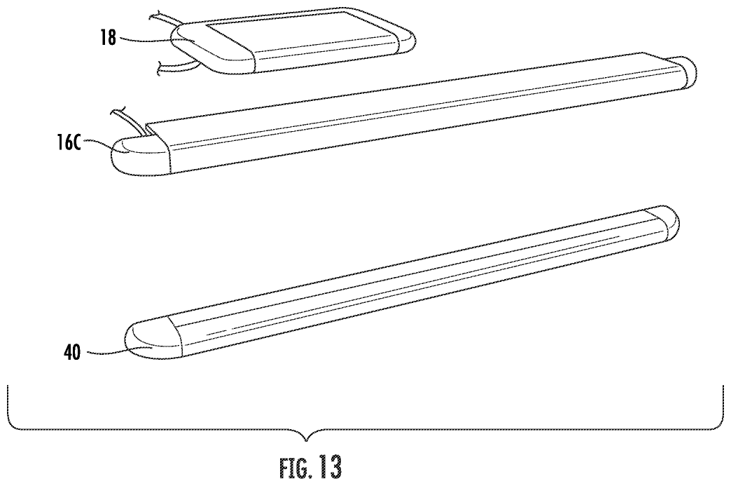

According to other embodiments, one or more sensors 16C may emit a signal (e.g., a light signal) that is bounced or reflected back to the sensor. Measuring time-of-flight of such signals may be used to monitor attempted access to the fixture 14. In some cases, the sensor(s) 16C may emit signal(s) that are reflected back to the sensor with only some of the reflected signals being detected by the sensor (see, e.g., FIG. 12A). In other cases, the system 10 may include a reflective component 40 that is configured to reflect the signals transmitted by the one or more sensors 16. In one example, the reflective component 40 is a reflective strip, such as tape. FIG. 12B shows an embodiment where the reflective component 40 is a retroreflective tape, which facilitates the detection of a greater number of return signals than a conventional reflector. In other words, the retroreflective tape is configured to collect all or mostly all of the signals emitted by the sensor 16C versus only the signals directly below the sensor (e.g., compare FIGS. 12A-C). Retroreflective tape may be configured to refract incident light signals such that the light signals exit in the same direction that they arrived. Moreover, use of a retroreflective tape may enable greater control over the field-of-view of the sensor(s) 16C. Thus, more focused signal(s) may be emitted by the sensor(s) 16C which may provide for better range and/or more accurate monitoring and detection of access attempts. As shown in FIGS. 12A-B, the sensor(s) 16C may be located along a top edge of the fixture 14, while the reflective component 40 may be located along a bottom edge of the fixture. In this way, the reflective component 40 may be located a predetermined distance from the sensor(s) 16C, and time-of-flight may be used to determine if there is an interruption in the signals or if an object is placed between the sensor(s) 16C and the reflective component 40. Thus, signals transmitted and received by the sensor(s) 16C may be used to detect unauthorized access attempts.

It is understood that other techniques may be used to determine if there is an unauthorized access attempt. For example, rather than using reflective properties, e.g., using a reflective component, a non-reflective component may be employed. Where a non-reflective component is used (e.g., a dark or absorptive component), there would be no return signal transmitted back to the sensor 16C. Thus, in the normal operating mode, the sensor 16C would not detect any reflective signals. In this way, the sensor 16C may be configured to detect a reflective signal indicative of an unauthorized access attempt, which may result from a hand or object being placed within the path of the signal transmitted by the sensor. Moreover, the sensors 16C may be configured to auto-calibrate in real-time or on a periodic basis to ensure that accurate measurements are taken and/or that unauthorized access attempts are detected. For instance, if the sensor 16C is moved from its installed location on the fixture 14 and/or the reflective component 40 is tampered with in some way, the sensor may be configured to detect the unauthorized tampering. Thus, different types of unauthorized access may be able to be detected (e.g., an attempt to access the fixture or fixture contents versus an attempt to tamper with the sensors or other components of the system 10). Moreover, it is understood that various types of sensing modalities may be employed in addition to those disclosed here, such as, for example, capacitive sensors. For instance, a capacitive sensor may be configured to detect electrical properties to determine the presence of a user or access attempt.

The sensor 16 may have a power source (e.g., battery) for providing power for operating the wireless communications circuitry, as well as any other components requiring power (e.g., an emitter). In other cases, an external power source may be provided, such as via the monitoring device 18 or junction box 20. In one embodiment, the sensor 16 may be configured to “wake up” only periodically to take a measurement. This could be a predefined time period, such as every 15 minutes, or it could have a more sophisticated control. For example, the sensor 16 could be programmed to wake up more often during peak times of the day and wake up less often (or not at all) during certain hours (e.g., after hours). For instance, the sensor 16 may have a clock time link via the monitoring device 18 to know what time of day it is. This schedule could also be set automatically by the system 10 (as opposed to a user-inputted schedule) by the system watching and learning over time about what times the data center and fixtures are accessed and adjusting the scanning schedule appropriately. Thus, in some embodiments, the sensor 16 may not be required to have external power or a large battery, which may extend the life of the sensor. In some cases, the sensor 16, upon waking up and detecting any item or person, could enter into a higher-scan mode (e.g., scanning more frequently than the standard predefined time period) for some specified period of time. For example, the high-scan mode can be used to measure when any item is removed or accessed and report that to the system 10.

In some embodiments, a plurality of sensors 16 may communicate with one monitoring device 18. Thus, the monitoring device 18 may be configured to monitor a plurality of signals provided by the sensors 16. In some instances, each sensor 16 may be wirelessly paired to a monitoring device 18, such as, for example, via Bluetooth communication. Pairing may include the exchange of a particular code or identifier that associates a sensor 16 with a monitoring device 18. An authorized user may initiate communication between a sensor 16 and a monitoring device 18 for pairing or unpairing with one another, such as by pressing an actuator on the sensor and/or the monitoring device. Therefore, any number of sensors 16 may be added to or removed from the system 10, and likewise a plurality of monitoring devices 18 may be employed.

The sensor 16 and/or the monitoring device 18 may further be configured to facilitate communication with one or more remote devices 30 (e.g., smartphone or tablet or computer) for providing notification regarding various events and/or data (see, e.g., FIG. 9). FIGS. 8-9 show that status (e.g., an authorized access attempt) may be communicated to a remote device 30. Such communication could occur, for instance, over one or more wireless communication protocols. For instance, a private local network 25 may be used to facilitate communication between the sensor 16 and a monitoring device 18 (e.g., via the LoRa network or Wi-Fi network or Ethernet connection), and public network 35 could be sent to the remote device 30 (e.g., via a cloud network). In other embodiments, the sensor 16 and/or the monitoring device 18 may be configured to generate an alarm signal should an unauthorized access attempt be detected. In some embodiments, reports may be generated at the associate device 20 and/or monitoring device 18 which may be used to collect and manage data regarding each of the sensors 16 and/or monitoring devices 18.

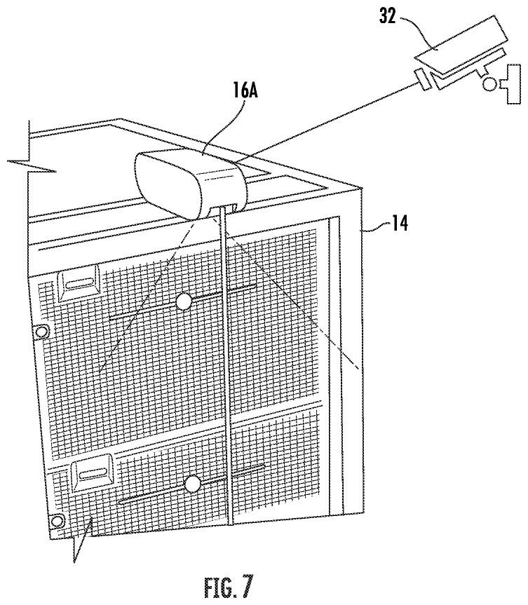

Moreover, FIG. 7 shows that the system 10 may further include one or more cameras 32. The cameras 32 may be configured to monitor any desired component, such as for example, the sensors 16 and/or fixtures 14. The cameras 32 may be configured to simply record images or video or could further include functionality to communicate data to and from each of the sensors, such as via light-based communication. Thus, in some embodiments, the monitoring device 18 could take the form of a camera 32 for obtaining various information from the sensors 16.

In some embodiments, a device 20 may have a set-up mode used to associate the sensor 16 with a specific fixture 14 or equipment stored by the fixture. The set-up mode could be initiated with a button push or other mechanism that is activated by the installer on the sensor 16. In some cases, an identifier on the sensor 16 may be associated with an identifier on the fixture 14. For example, a device 20 may be configured to scan a UPC or QR code on both the sensor 16 and the fixture 14 and/or equipment to associate the two.

Embodiments of the present invention may utilize similar technology as that disclosed in U.S. Pat. Nos. 10,140,824, 10,535,239, PCT Publication No. WO 2020/227513, U.S. Publ. No. 2021/0264754, PCT Publication No. WO 2020/198473, International Appl. No. PCT/US2021/070993, and U.S. Provisional Appl. No. 63/059,280, the contents of which are each hereby incorporated by reference in their entirety herein.

The foregoing has described one or more embodiments of systems and methods for data center security. Although embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

That which is claimed is:

1. A data center monitoring system comprising:
at least one sensor configured to be attached to a fixture in a data center, wherein the at least one sensor is configured to transmit a wireless signal for detecting an unauthorized access attempt to the fixture; and
at least one monitoring device configured to communicate with the at least one sensor, wherein the at least one monitoring device is configured to receive a signal from the at least one sensor indicative of the unauthorized access attempt to the fixture.

2. The data center monitoring system of claim 1, wherein the fixture is a server rack or server cabinet.

3. The data center monitoring system of claim 1, wherein the fixture defines an enclosure within an access opening, and wherein the at the at least one sensor is configured to transmit the wireless signal for detecting unauthorized access into the opening.

4. The data center monitoring system of claim 1, wherein the at least one sensor or the at least one monitoring device is configured to communicate a notification message to one or more remote devices.

5. The data center monitoring system of claim 1, wherein the at least one sensor is configured to wirelessly communicate with the at least one monitoring device.

6. The data center monitoring system of claim 1, wherein the at least one sensor is electrically connected to the at least one monitoring device via one or more cables.

7. The data center monitoring system of claim 1, wherein the at least one monitoring device is a controller.

8. The data center monitoring system of claim 1, wherein the at least one monitoring device is a computer.

9. The data center monitoring system of claim 1, further comprising a plurality of sensors, each sensor coupled to a respective fixture.

10. The data center monitoring system of claim 9, wherein the at least one monitoring device is configured to communicate with each of the plurality of sensors.

11. The data center monitoring system of claim 1, further comprising a junction box configured to communicate with the at least one sensor and the at least one monitoring device.

12. The data center monitoring system of claim 11, wherein the junction box is configured to electrically connect to a plurality of sensors.

13. The data center monitoring system of claim 1, wherein the wireless signal is at least one optical signal for detecting an unauthorized access attempt to the fixture.

14. The data center monitoring system of claim 1, wherein the at least one sensor is an array of sensors configured to transmit a plurality of optical signals for detecting an unauthorized access attempt to the fixture.

15. The data center monitoring system of claim 1, further comprising a camera for capturing one or more images of the fixture.

16. The data center monitoring system of claim 1, further comprising an access control point coupled to the fixture and configured to control access to the fixture.

17. The data center monitoring system of claim 16, wherein the access control point is configured to communicate with a key for arming or disarming the access control point.

18. The data center monitoring system of claim 1, wherein the wireless signal is at least one light signal for detecting an unauthorized access attempt to the fixture.

19. The data center monitoring system of claim 18, further comprising a reflective component spaced a predetermined distance from the at least one sensor, wherein the reflective component is configured to reflect the at least one light signal back to the at least one sensor.

20. The data center monitoring system of claim 19, wherein the reflective component comprises a retroreflective tape.

21. The data center monitoring system of claim 1, wherein the at least one sensor is configured to detect an interruption in the wireless signal.

22. The data center monitoring system of claim 21, wherein the at least one sensor is configured to detect an interruption in the wireless signal using time of flight.

23. A data center monitoring system comprising:
a plurality of server racks located in a data center;
a plurality of sensors each configured to be attached to a respective server rack, each sensor configured to transmit a wireless signal for detecting an unauthorized access attempt to the server rack; and
at least one monitoring device configured to communicate with each of the plurality of sensors, the at least one monitoring device configured to receive a signal from each of the plurality of sensors indicative of an unauthorized access attempt to a respective server rack.

24. A method for monitoring a data center comprising:
transmitting a wireless signal with at least one sensor attached to a fixture in a data center for detecting an unauthorized access attempt to the fixture; and
receiving a signal at a monitoring device from the at least one sensor indicative of the unauthorized access attempt to the fixture.

25. The method of claim 24, wherein transmitting comprises transmitting at least one optical signal with the at least one sensor.
